(19) United States
(12) Patent Application Publication
(10) Pub. No.: US 2020/0334680 A1
(43) Pub. Date: Oct. 22, 2020

(54) DETECTING ANOMALOUS TRANSACTIONS USING MACHINE LEARNING

(71) Applicant: PayPal, Inc., San Jose, CA (US)

(72) Inventors: Siva Surya Teja Vanga, Anaparthi (IN); Ritesh Arora, Fremont, CA (US)

(21) Appl. No.: 16/391,052

(22) Filed: Apr. 22, 2019

(51) Int. Cl. G06Q 20/40; G06Q 40/04; G06N 20/00

(52) U.S. Cl. CPC G06Q 20/4016; G06N 20/00; G06Q 40/04

(57) ABSTRACT

Techniques are disclosed relating to detecting anomalous transactions using machine learning. For example, in various embodiments, an anomaly detection computer system may access an input dataset that includes data indicative of transactions submitted to a transaction network for both a first entity and by a plurality of other entities. The computer system may parse this input dataset and, based on a set of data feature definitions, determine a training dataset. The computer system may then train an autoencoder machine learning model based on the training dataset such that, once trained, the autoencoder is operable to detect one or more anomalous transactions submitted for the first entity to the transaction network during a specified time period.

### BACKGROUND

### Technical Field

This disclosure relates generally to machine learning and, more particularly, to detecting anomalous transactions using machine learning.

### Description of the Related Art

Market participants are required to adhere to a variety of trading regulations to prevent various types of illicit trading practices, such as insider trading and market manipulation. Failing to comply with these regulations can result in significant consequences, with fines reaching the tens of millions of dollars. Accordingly, trading entities audit their trading activities to ensure that they do not violate any applicable trading regulations. However, most entities still monitor trading activities using static, business-specific rules written by domain experts to flag a specific pattern or behavior as anomalous. Although such a system is simple to implement, it suffers from various technical shortcomings. For example, such rules-based systems are reactive in nature and are ill-suited to detecting emerging patterns of illicit trading behavior.

### BRIEF DESCRIPTION OF THE DRAWINGS

FIG. 1 is a block diagram illustrating an example high-frequency transaction system 100 in which various disclosed embodiments may be implemented, according to some embodiments.

FIG. 2 is a block diagram illustrating an example anomaly detection module, according to some embodiments.

FIG. 3 is a block diagram illustrating an example autoencoder, according to some embodiments.

FIG. 4 is a flow diagram illustrating an example method for detecting anomalous transactions using machine learning, according to some embodiments.

FIG. 5 depicts a series of transactions that may be submitted in the high-frequency transaction system 100 of FIG. 1, according to some embodiments.

FIG. 6 is a block diagram illustrating an example computer system, according to some embodiments.

### DETAILED DESCRIPTION

Market participants are required to adhere to a variety of global trading regulations to prevent various types of illicit trading practices, such as insider trading and market manipulation. As described in more detail below one form of market manipulation, for example, is “spoofing,” in which a trader creates a false demand or supply in the market by submitting multiple buy or sell orders in bad faith with the intention of canceling those orders before they are executed. When a trader places multiple orders in this manner, it may change the existing bid and ask prices for the security at-issue, allowing the trader to then place orders on the opposite side of the market and leverage this price change. The effects of such behavior are exacerbated in the context of high-frequency trading, in which trades are performed on the order of milliseconds.

The consequences for violating trading regulations are significant, with fines for violations reaching the tens of millions of dollars. To ensure compliance with these regulations, trading parties engage in the act of “trade surveillance” to audit their trading activities. Trade surveillance is the process of monitoring trades submitted for a given entity to ensure that the trades do not violate any applicable trading regulations. Trade surveillance teams are also typically responsible for the investigation and documentation of transactions that are flagged by the rules, either escalating the transaction or closing it as a false alert.

Unfortunately, however, most organizations still monitor trading activities using static, business-specific rules that are written by domain experts to flag a specific pattern or behavior as anomalous. Although such a system is simple to implement, it suffers from various technical shortcomings. With the increasing volume of trades, these systems generate many alerts and it takes a lot of analyst time to manually evaluate each of these flagged transactions. For example, in some instances, the rules-based systems may flag a high number of transactions in a given day (e.g., 10,000 or more) as being potentially anomalous, only to find, after manual review, that none or a small number (e.g., 10) of the flagged transactions were actually anomalous. Thus, in various instances, traditional rules-based anomaly detection systems may generate a high percentage of false positives, resulting in wasted time and resources to manually review the incorrectly flagged transactions. Further, prior rules-based anomaly detection systems are reactive (rather than proactive) in nature and, as such, are ill-suited to adapt to emerging patterns of illicit trading behavior. For example, for such systems to catch a newly deployed illicit trading behavior, they rely on subject matter experts to first become aware of this pattern and then write a specific rule designed to detect this new trading behavior. This delay period—between the illicit trading behavior being adopted and the implementation of the rule—may allow such trading behaviors going undetected until the rule is put into place, potentially resulting in violations of trade regulations and the resulting penalties.

In various embodiments, the disclosed systems and methods may address these or other technical problems by detecting anomalous transactions using machine learning. For example, in various embodiments, an anomaly detection system may access an input dataset that includes market data indicative of transactions submitted to a transaction network for both a first entity and for the market as a whole. The anomaly detection system may parse this input dataset and, based on a set of data feature definitions, create a training dataset. Continuing with the example above, one such data feature definition may ask, how many total orders were submitted for one entity during the last 3 milliseconds. The anomaly detection system may then train an autoencoder machine learning model based on the training dataset such that, once trained, the autoencoder is operable to detect one or more anomalous transactions submitted for the first entity to the transaction network during a specified time period.

As used herein, the term “anomaly detection” refers to the process of identifying observations that deviate from the patterns followed by the majority of the other observations in a dataset. Continuing with the above example, in the context of a transaction system, an anomaly may be one or more transactions that violate a given trading regulation and, as such, deviate from the majority of other transactions performed via the system that do not violate the regulation. Note that, although described below in the context of trade surveillance, the disclosed systems and methods for detecting anomalous activity using machine learning may be implemented in any other suitable technical domain, including cyber security, medical diagnosis, mechanical component failure analysis, etc.

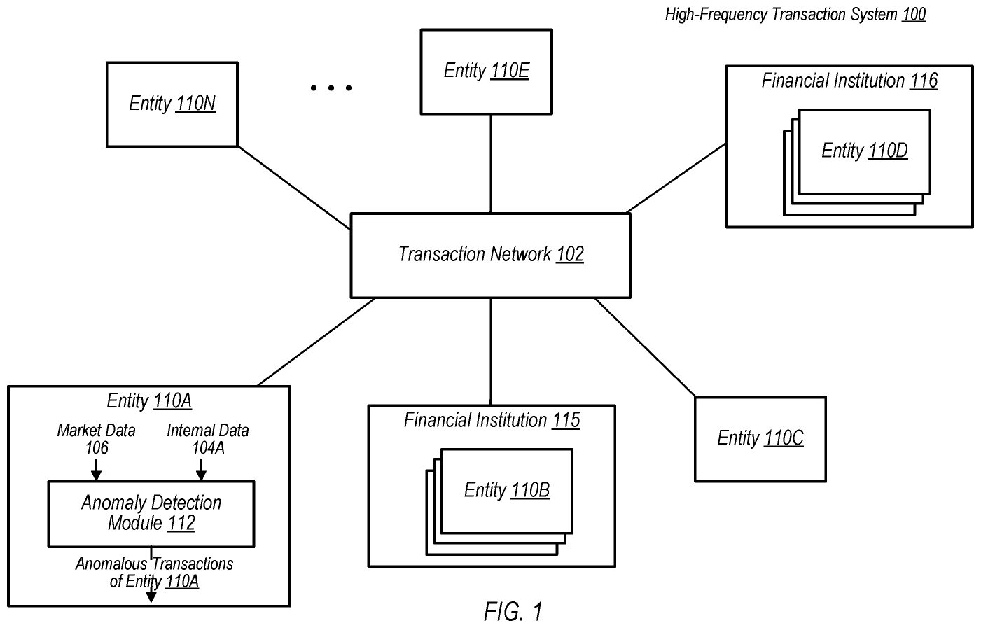

Referring now to FIG. 1, a high-frequency transaction system 100 is depicted, according to some embodiments. In the depicted embodiment, the high-frequency transaction system 100 includes computer systems for various entities 110 and financial institutions 115-116 coupled to a transaction network 102. Note that, although shown in direct communication, one or more of the entities 110 and financial institutions 115-116 may be connected to the transaction network 102 via one or more communication networks (not shown for clarity).

In various embodiments, transaction network 102 may enable entities 110 to trade securities on any suitable exchange (e.g., the NYSE, Dow Jones, Nasdaq Stock Market, etc.). In the depicted embodiment, system 100 is a high-frequency transaction system in which one or more of the entities 110 may engage in high-frequency securities trading. As will be appreciated by one of skill in the art, the term “high-frequency trading” refers generally to the practice of using a software platform to submit a large number of transactions in a short period of time, often on the order of milliseconds or microseconds. High-frequency trading platforms typically use complex algorithms to conduct trading strategies that leverage their ability to submit transactions at high speeds to capture incremental returns (e.g., fractions of one cent) on a given transaction. When extrapolated over a high volume of transactions, however, these incremental returns can yield significant profit.

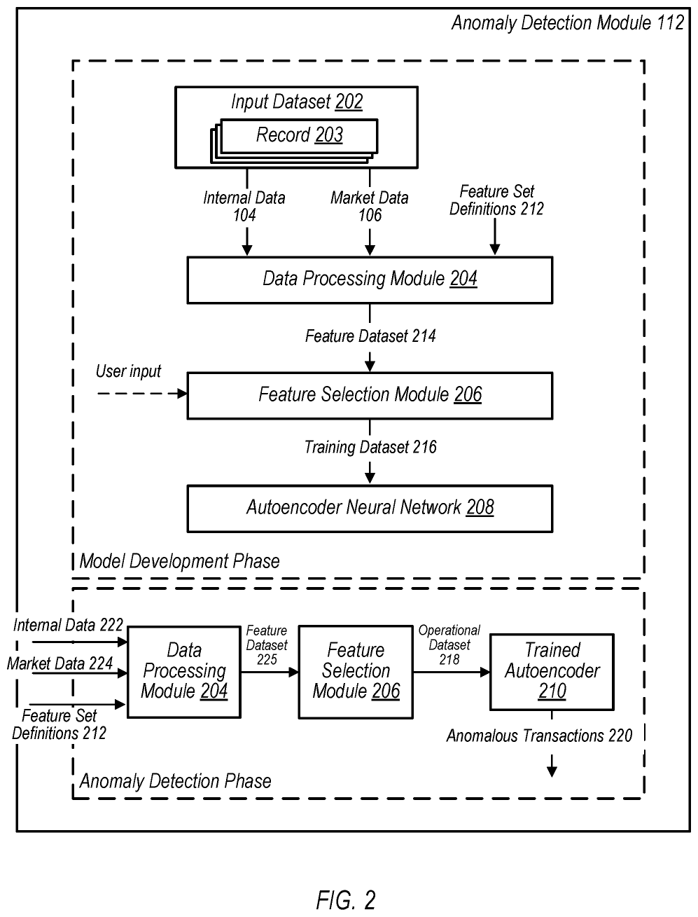

As noted above, traders (including high-frequency traders) are subject to a variety of trading regulations, the failure to comply with which can result in significant consequences. Thus, in various instances, one or more of the entities 110 of FIG. 1 may engage in trade surveillance to audit their trading behavior to ensure that they do not, knowingly or unknowingly, violate applicable trading regulations. For example, as shown in FIG. 1, entity 110A includes anomaly detection module 112. As described in more detail below with reference to FIG. 2, anomaly detection module 112, in various embodiments, is operable to train an autoencoder machine learning model to detect anomalous transactions. Once trained, the autoencoder of anomaly detection module 112 may then be used to identify anomalous trading behavior in the (potentially numerous) transactions submitted for entity 110A to transaction network 102. As a non-limiting example, a trade surveillance team associated with entity 110A may conduct a periodic audit (e.g., at the end of the day, week, etc.) using anomaly detection module 112 to determine whether it has performed any anomalous transactions during the audit period. Note, however, that in some embodiments, the disclosed systems and methods may also be used to identify anomalous transactions in real-time or near real-time, for example as transactions are submitted to the transaction network 102 for an entity 110.

In various embodiments, anomaly detection module 112 may use both internal data 104A and market data 106 to train the autoencoder machine learning model, as described in more detail below. For example, in some embodiments, the internal data 104A may include information about all of the transactions submitted for entity 110A during a given time period (e.g., one day, one hour, etc.) while the market data 106 includes similar information for the larger market as a whole. As a non-limiting example, internal data 104A may specify, for a given transaction, one or more of the following items of information: time of the transaction, the security involved, whether the entity seeks to buy or sell, type of transaction (e.g., offer, amend, delete, etc.), price, deviation from trading price, quantity, identity of trader (e.g., entity 110A), etc. Further, in various embodiments, the market data 106 may include similar data for all of the transactions submitted to the transaction network 102 for the entire market (e.g., all of entities 110), including entity 110A, during the same time period. In various embodiments, this internal data 104A and market data 106 may be used as a training dataset to train an autoencoder machine learning model.

As noted above, once the autoencoder is trained using the internal and market data, it may be used to identify anomalous transactions submitted to the transaction network 102 for a given entity 110. In various embodiments, the anomaly detection module 112 may generate an anomaly score for each of the anomalous transactions it identifies. As discussed in more detail below, this anomaly score, in various embodiments, indicates the extent to which a given anomalous transaction deviates from the “normal” pattern of market behavior learned by the autoencoder during the model development phase. Anomaly detection module 112 may then generate a list of the anomalous transactions it identifies, ranked based on their respective anomaly scores. In some embodiments, the list may further specify, for each of the anomalous transactions, the data features that contributed to its classification as an anomaly. In various embodiments, this ranked list of anomalous transactions, along with specification of the contributing data features, may aid analysts in manual review of these anomalous transactions.

The disclosed systems and methods, in various embodiments, offer a variety of technical improvements over prior systems in the context of trade surveillance. For example, in various embodiments, the disclosed anomaly detection techniques are proactive in nature and—unlike prior rules-based systems—are able to adapt to emerging patterns of trading behavior. As noted above, for instance, traditional rules-based systems rely on analysts to first learn of an emerging illicit trading practice (potentially after it has already been performed via the analyst's system) and then write a business-specific rule to attempt to identify instances of that practice in the future. In various embodiments, however, the disclosed systems and methods use an autoencoder machine learning model to detect those transactions that deviate from the patterns followed by the majority of transactions in the market, allowing the disclosed systems to respond quickly to emerging trade practices. This, in turn, may allow the disclosed system to identify anomalous transactions that would have otherwise gone undetected using a traditional rules-based system.

Further, in various embodiments, the disclosed techniques for anomaly detection using machine learning allow for multiple data features to be considered together when identifying anomalous transactions. For example, in prior systems, a business-specific rule is typically constructed as one or more conditional statements that assume data features are independent and, as such, the rules evaluate these data features independently. In various embodiments, however, the disclosed techniques are operable to consider the combination of data features when determining whether a given trade or series of trades was anomalous or conformed to larger market behavior. This property of the disclosed systems and methods may present various benefits. For example, in some embodiments, the present techniques can detect a given transaction as anomalous even when its individual features, when considered individually, do not seem to be anomalous.

Additionally, in some embodiments, the disclosed systems and methods result in more accurate anomaly detection than that offered by prior rules-based systems. For example, rules-based systems rely on subject matter experts to craft business-specific rules that are calculated to identify certain types of trading behavior. Typically, such rules will include threshold values against which to test a given condition. For example, one such rule could provide as follows: if entity 110A submits more than 75 buy orders for Security A in one minute, flag the 75^{th} transaction as anomalous. One problem with such an approach, however, is its reliance on threshold values that may be either too high to catch an anomalous transaction or so low that it incorrectly flags transactions that are not anomalous. In various embodiments, however, the disclosed systems and methods avoid the problems of stringent reliance on manually established threshold values by instead detecting anomalous transaction using machine learning techniques to identify those transactions that deviate from patterns followed by the majority of transactions. This, in turn, may result in fewer false flags, saving analyst time for manual review, and in the detection of anomalous transactions that would have otherwise gone undetected using prior systems.

As used herein, the term “entity” refers to a party for which a transaction is submitted to the transaction network 102. In some embodiments, an entity may submit transactions to transaction network 102 for itself. For example, in FIG. 1, entity 110A may submit transactions to transaction network 102 on its own behalf. In other embodiments, however, an entity may be associated with a financial institution, investment firm, broker-dealer, or other party that submits transactions to the transaction network 102 for the entity. In FIG. 1, for example, multiple entities, including entity 110B, are associated with financial institution 115, which may submit transactions to transaction network 102 for these multiple entities 110. Additionally, note that “submitting a transaction” to the transaction network 102 does not necessarily imply that the transaction is actually executed once received at the transaction network 102. For example, entity 110A may submit a transaction to transaction network 102 offering to buy a particular security. Prior to this offer being fulfilled, however, entity 110A may submit a subsequent transaction to transaction network seeking to amend or cancel the original transaction.

Further note that, in some embodiments, the disclosed techniques for detecting anomalous transactions using machine learning may be performed by the entity 110 that is submitting the transactions to the transaction network 102, as shown in FIG. 1. In other embodiments, however, one or more of entities 110 may delegate their trade surveillance obligations to a third-party service that is capable of detecting anomalous transactions using machine learning, as disclosed herein. As a non-limiting example, in some embodiments, system 100 may further include a separate server system (not shown in FIG. 1, for clarity) that is operable to receive data, including internal data 104 and market data 106, and use anomaly detection module 112 to perform trade surveillance for one or more entities 110. Note that, in embodiments in which a third-party service performs trade surveillance for multiple entities, such as entities 110A and 110B in the depicted embodiment, each of entities 110A and 110B may provide, in addition to market data 106, internal data 104A and 104B to the third-party service (respectively corresponding to the internal data for entities 110A and 110B). Using this data, the trade surveillance service may train one or more autoencoder machine learning models and detect anomalous transactions associated with the entities 110A and 110B.

Turning now to FIG. 2, an example anomaly detection module 112 is depicted, according to some embodiments. Anomaly detection module 112 is operable to detect anomalous transactions using machine learning, according to various embodiments. In the depicted embodiment, for example, anomaly detection module 112 is used to detect one or more anomalous transactions submitted to transaction network 102 by entity 110A.

As shown in FIG. 2, anomaly detection module 112, in various embodiments, operates in two phases, a model development phase and an anomaly detection phase. During the model development phase, the anomaly detection module 112 generates a trained autoencoder machine learning model 210, which may be used during the anomaly detection phase to detect anomalous transactions associated with a trading entity 110.

In FIG. 2, the model development phase begins with data processing module 204, which, in various embodiments, is operable to analyze the input dataset 202 based on a feature set definitions 212. As shown in FIG. 2, input dataset 202 includes both internal data 104A and market data 106. Internal data 104A may include various items of information about the transactions submitted for entity 110A, to transaction network 102, during a given time period (e.g., one day, one week, one month, etc.). For example, in some embodiments, internal data 104A may specify, for the transactions submitted for entity 110A, the times of the transactions, the security involved, action taken (e.g., buying or selling a security), type of transaction (e.g., offer, amend, delete, etc.), price, deviation from trading price, quantity, identity of trader (e.g., entity 110A, in this example), etc. In various embodiments, market data 106 may specify similar information regarding the transactions submitted on the transaction network 102 as a whole, including all of the transactions submitted for each of the entities 110 over that same time period. For example, the market data 106 may include, for each transaction submitted to transaction network 102 over the given time period: time of the transaction, security involved, type of transaction, price, quantity, action taken, deviation from trading price, identity of trader, etc.

In various embodiments, it is desirable to use both internal data 104A and the market data 106 to detect anomalous transactions submitted for entity 110A to differentiate between transactions that are actually anomalous and those transactions that only appear to be anomalous when considered in isolation. Stated differently, some transactions may appear to be anomalous when taken individually, but when compared to the market behavior as a whole, it is determined that those transactions are actually consistent with the behavior of the other trading entities. For example, consider an instance in which entity 110A typically submits between 25-50 transactions to transaction network 102 in a given minute of active trading. If there is then a period in which entity 110A submits significantly more transactions (e.g., 200 transactions) during a one-minute period, many prior rules-based systems would flag this trading behavior as anomalous. It may be the case, however, that there was a market event that motivated many entities, including entity 110A, to drastically increase the number of transactions submitted during that one-minute period. Thus, by using both internal and external data to identify anomalous transactions, various embodiments are able to differentiate between those transactions that are anomalous and those that merely appear anomalous in isolation.

FIG. 2 further depicts feature set definitions 212. As will be appreciated by one of skill in the art with the benefit of this disclosure, the term “feature” or “data feature” refers to a property or characteristic of an observation in a dataset. In various embodiments, the particular features defined in feature set definitions 212 may be selected by an analyst (e.g., a trade surveillance analyst) or other subject matter expert familiar with those data features that are indicative of anomalous activity in the relevant context. In various embodiments, data processing module 204 is operable to create the feature dataset 214 based on the input dataset 202 and the feature set definitions 212. For example, for a given record 203 in input dataset 202 (e.g., a record specifying the details of a transaction), data processing module 204 may use the set of feature definitions to create feature data (e.g., values for each of the features defined by feature set definitions 212) for the record 203. Data processing module 204 may evaluate all (or a substantial percentage) of the records in input dataset 202 in a similar manner and create feature dataset 214 specifying the outcome of these evaluations. Note that, in some embodiments, data processing module 204 may create the feature dataset 214 by processing the input dataset 202 in batches. That is, the input dataset 202 may be split into multiple batches and data processing module 204 may process the batches in parallel to create the feature dataset 214.

In the depicted embodiment, feature set definitions 212 includes a set of features that will be useful to anomaly detection module 112 to detect anomalous transactions in the context of high-frequency transaction system 100. In some embodiments, for example, the feature set definitions 212 may include features that attempt to quantify the behavior of a given entity based on the internal and market data and may be defined per security or per security/per entity. The following are non-limiting examples of features that may be included in feature set definitions 212 to quantify entity behavior, according to various embodiments: total number of trades executed, sum of quantity of orders entered, average quantity of trades, average price of trades, deviation from best bid or best ask prices, success ratio (e.g., cumulative orders/cumulative trades), market share (e.g., ratio of cumulative quantity of internal trades relative to cumulative quantity of market), etc. Note that, in some embodiments, feature set definitions 212 may include both transaction-related features and features related to other activities by the entity (e.g., total number of activities, sum of quantity of other activities, average quantity of other activities, average price of other activities, absolute sum of change in ticks (from last trade price), average change in ticks (from last trade price), etc.).

Further, in various embodiments, one or more of the features in feature set definitions 212 may attempt to quantify the deviation of a transaction from the existing market environment, such as: the price difference between the current order price and the last traded price, the percent difference between the current order price and the last traded price, the ratio of current order price to the last traded price, time since the last order on the buy or sell side, time since the last delete on the buy or sell side, time since the last amend on the buy or sell side, etc. Additionally, in some embodiments, the features in feature set definitions 212 may attempt to quantify the behavior of the entities 110 based on various time-series features, such as: the number of orders per entity in the last 1 ms, 2 ms, etc., number of amends per entity in the last 5 ms, 10 ms, etc., number of deletes per entity in the last 20 ms, sum of quantity of trades in the last 50 ms, 100 ms, etc., ratio of orders to amends in the last 500 ms, ratio of quantity of deletes to quantity of orders in the last second, etc. Note, however, that the above-listed features are provided merely as an example and are not intended to limit the scope of the present disclosure. In other embodiments, any suitable combination of features may be included in feature set definitions 212.

Additionally, note that the specific features included in the feature set definitions 212 will vary, in some embodiments, depending on the context in which the anomaly detection module 112 is implemented. That is, in embodiments in which the anomaly detection module 112 is used to detect anomalous events in a different context, the feature set definitions 212 will be adjusted appropriately. As one non-limiting example, for embodiments in which the anomaly detection module is used in the context of cyber security to identify anomalous access requests, the feature set definitions 212 may include data features relevant to such a determination, such as origin IP address, number of access requests sent within a given time period, etc.

In various embodiments, feature set definitions 212 may include any suitable number of features. For example, feature set definitions 212 may include 100, 150, 200, or any other number of features suitable for the given context. In some embodiments, it may be desirable to reduce the number of features used to train the autoencoder 208, using the fewest number of data features necessary to represent the information contained feature dataset 214. Using this approach may present various benefits. For example, in some instances, machine learning algorithms are more effective using as many datapoints as possible with as few features per datapoint as necessary to capture the all of the information from the datapoint. The remaining features that are not used may, in some embodiments, be thought of as noise that does not improve the efficacy of the machine learning algorithms. In the depicted embodiment, anomaly detection module 112 includes feature selection module 206, which, in various embodiments, is operable to select a reduced set of features from feature dataset 214. This reduced set of features, in various embodiments, may be used as training data 216 to the autoencoder neural network 208, as discussed below. Note that, in some embodiments, the reduced set of features may be selected based on user input, as shown in FIG. 2. For example, in some embodiments, an analyst may select, during the model development phase, the reduced feature set to be used to train the autoencoder neural network 208.

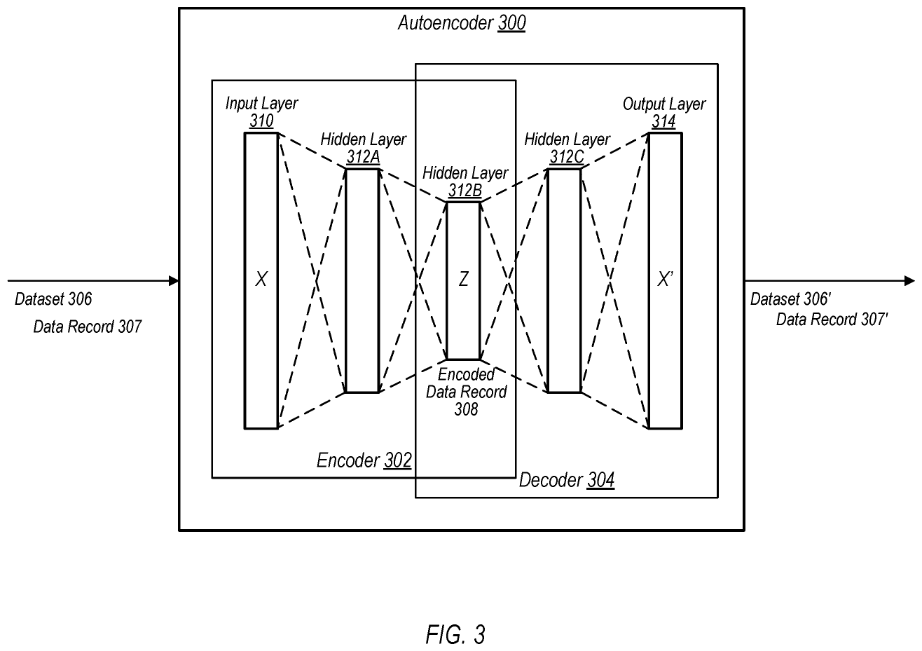

FIG. 2 further includes autoencoder neural network 208, which is a neural network that may be used for unsupervised machine learning to detect outliers, such as anomalous transactions, in a dataset. In the depicted embodiment, autoencoder neural network 208 is operable to use reduced set of features as a training dataset 216. As described in more detail below with reference to FIG. 3, training autoencoder neural network 208 is a two-step process in which the autoencoder first attempts to learn the internal patterns present in the training dataset 216 by encoding that data into a lower dimensionality. In the second step, the autoencoder then attempts to reconstruct the training dataset 216 from its encoded form, thereby learning to reconstruct the input data. Through this process of deconstructing and reconstructing the training dataset 216, the autoencoder learns the salient features and patterns followed by the majority of the observations in dataset 216. As a result, once trained, the autoencoder is able to identify those observations that deviate from the patterns followed by the majority of observations in the training dataset 216.

After the model development phase is complete, trained autoencoder 210 may be used, during the anomaly detection phase, to identify one or more anomalous transactions 220 included in an operational dataset 218. For example, as noted above, various entities 110 in the system 100 may engage in trade surveillance to ensure their compliance with various applicable trading regulations. As such, those entities 110 (or a third-party service to which they have delegated their trade-surveillance operations) may audit their trading activities on a periodic basis, such as at the end of every day, end of the week, end of the month, etc. Further, as noted above, in some embodiments one or more entities are associated with a party, such as a financial institution, investment firm, broker-dealer, or other party that submits transactions to the transaction network 102 for those one or more entities. In some such embodiments, that party (e.g., financial institution 115 of FIG. 1) may audit the transactions submitted to transaction network 102 for one or more of the entities 110 (e.g., entity 110B, in FIG. 1) that are associated with it. In the depicted embodiment, assume that anomaly detection module 112 is being used to audit the trading behavior of entity 110A over for a one-day period. In this embodiment, the anomaly detection module 112 may receive an operational dataset 218 that corresponds to this one-day period. In various embodiments, operational dataset 218 may be based on internal data 222 and market data 224 corresponding to the audit period (e.g., one day, in the above example). In various embodiments, the internal data 222 and market data 224 may include similar items of information to that contained in the input dataset 202, such as the times of transactions, security involved, identity of trader, etc. Similar to training dataset 216, operational dataset 218 may be created based on internal data 222 and market data 224 along with the feature set definitions 212. In the depicted embodiment, for example, the data processing module 204 may create a feature dataset 225 from the internal data 222 and the market data 224 based on the feature set definitions 212. From this feature dataset 225, feature selection module 206 may be used to select a reduced feature dataset as the operational dataset 218, which may then be used as input to the trained autoencoder 210.

In various embodiments, trained autoencoder 210 is operable to analyze operational dataset 218 and detect one or more anomalous transactions 220 submitted to the transaction network 102 for entity 110A. For example, as explained in more detail below with reference to FIG. 3, trained autoencoder 210 may receive a data record for a transaction 221 as an input and attempt to generate a reconstruction of that data record as an output. The degree of deviation between the original input data and the regenerated output data is referred to as the “reconstruction error.” In various embodiments, anomaly detection module 112 is operable to determine whether a given record (and, by extension, the transaction it corresponds to) in operational dataset 218 is anomalous based on its reconstruction error after analysis by the trained autoencoder 210. For example, if trained autoencoder 210 is able to reconstruct the data record for transaction 221 such that there is a relatively low reconstruction error (e.g., below some predetermined threshold value), it is likely that the transaction 221 follows the patterns of the majority of records in the training dataset 216 used to train the autoencoder 210. If, however, the reconstruction error for the data record associated with transaction 221 is relatively high (e.g., exceeds some predetermined threshold value), it is likely that transaction 221 deviates from the majority of records analyzed during the model development phase and, as such, is anomalous. Thus, in various embodiment, autoencoder 210 is operable to analyze the records in operational dataset 218 and differentiate between the transactions that follow the patterns autoencoder 210 learned during the model development phase and those transactions that deviate from those learned patterns.

In various embodiments, the anomalous transactions 220 identified by autoencoder 210 may be provided to analysts (e.g., a trade surveillance team) to verify that the transactions 220 are indeed anomalous so that the appropriate corrective action may be taken. In some embodiments, anomaly detection module 112 will generate, for each of the anomalous transactions 220 it identifies in operational dataset 218, an “anomaly score” that corresponds to the reconstruction error respectively associated with the anomalous transactions 220. Stated differently, the anomaly score may be indicative of the degree to which the given anomalous transaction 220 deviates from patterns learned by autoencoder 210 during the model development phase. In some embodiments, the anomalous transactions 220 identified by the autoencoder 210 may be output as a list of transactions, ranked based on their respective anomaly scores such that the analysts may address these anomalies in order of magnitude. Further, in some embodiments, in addition to simply identifying the anomalous transactions 220, the output generated may further specify, for each anomalous transaction 220, the feature or combination of features that contributed to its designation as anomalous.

Referring now to FIG. 3, a schematic diagram demonstrating the basic operation of an autoencoder 300 is depicted, according to some embodiments. In various embodiments, autoencoder 300 may be used by anomaly detection module 112 to analyze transaction data and identify one or more anomalous transactions performed in high-frequency transaction system 100 of FIG. 1. As will be appreciated by one of skill in the art with the benefit of this disclosure, an autoencoder is a type of neural network that attempts to deconstruct and reconstruct an input dataset. In various embodiments, an autoencoder 300 may be used, for example, to detect outliers in a dataset using unsupervised machine learning. In the depicted embodiment, autoencoder 300 includes input layer 310, three fully connected hidden layers 312A-312C, and output layer 314. Note, however, that this embodiment is provided merely as an example and, in other embodiments, the structure of autoencoder 300 may vary.

As shown in FIG. 3, autoencoder 300 includes both an encoder 302 and a decoder 304. In various embodiments, training an autoencoder is a two-step, iterative process. During the first step, the encoder 302 attempts to learn the internal patterns present in a dataset by encoding the input data into a lower dimension. In the second step, the decoder 304 then decodes the encoded data back to its original dimension, thereby learning to reconstruct the input dataset from its encoded form. As a non-limiting example, assume an input record X has 50 data features (that is, record X has 50 dimensions). Encoder 302 may be used to compress the record X into a latent-space representation Z that has a lower dimensionality (e.g., represented using 20 dimensions determined by the encoder 302). Stated differently, this latent-space representation Z is a more dense representation of the input data record X.

In the depicted embodiment, for example, encoder 302 receives input dataset 306. In various embodiments, dataset 306 may correspond to training dataset 216 of FIG. 2 and include records corresponding to a large number (e.g., 1 million, 10 million, etc.) of transactions submitted for entities 110 to transaction network 102. Further, in some embodiments, each of the records in dataset 306 may have been analyzed based on a set of feature definitions (e.g., feature set definitions 212) deemed to be relevant to the identification of anomalous transactions. As shown in FIG. 3, dataset 306 includes data record 307. In the depicted embodiment, encoder 302 encodes the data record 307 into lower-dimensioned (that is, denser) encoded data record 308. By encoding the input data record 307 into a lower dimension in this first step, the encoder 302 captures the most important patterns that are present in the data record 307. Decoder 304 may then take this encoded data record 308 and attempt to reconstruct the original data record 307. During the model development phase, autoencoder 300 may perform this encoding and decoding process for all of the records in the input dataset 306. Thus, in various embodiments, autoencoder 300 will try to learn the patterns present in the input dataset 306 by going through each of the records in that input dataset 306.

Note, as indicated in FIG. 3, that there may be a deviation between the original input data record 307 and the reconstructed data record 307 caused by the encoding and decoding process. As noted above, this deviation between the original input value and the reconstructed output value is referred to as the reconstruction error. In various embodiments, autoencoder 300 is iteratively trained by attempting to minimize this reconstruction error such that the output X′ closely resembles the input X.

As noted above, through this training process of deconstructing and reconstructing the dataset 306, the autoencoder 300 is able to learn the salient features and patterns followed by the majority of observations in the dataset 306. Since anomalous events, by definition, deviate from the majority of observations in a dataset, the reconstruction error for the anomalous observations are high relative to “normal” observations in the dataset 306. Accordingly, in various embodiments, autoencoder 300 is able to identify transactions (e.g., specified in operational dataset 218 of FIG. 2) submitted to transaction network 102 that deviate from the patterns followed by the majority of records in the dataset 306 used to train the autoencoder 300. Stated differently, once trained, anomaly detection module 112 may use autoencoder 300 to identify transactions in new datasets that do not follow those patterns of normal trading behavior that were learned by autoencoder 300 during the model development phase.

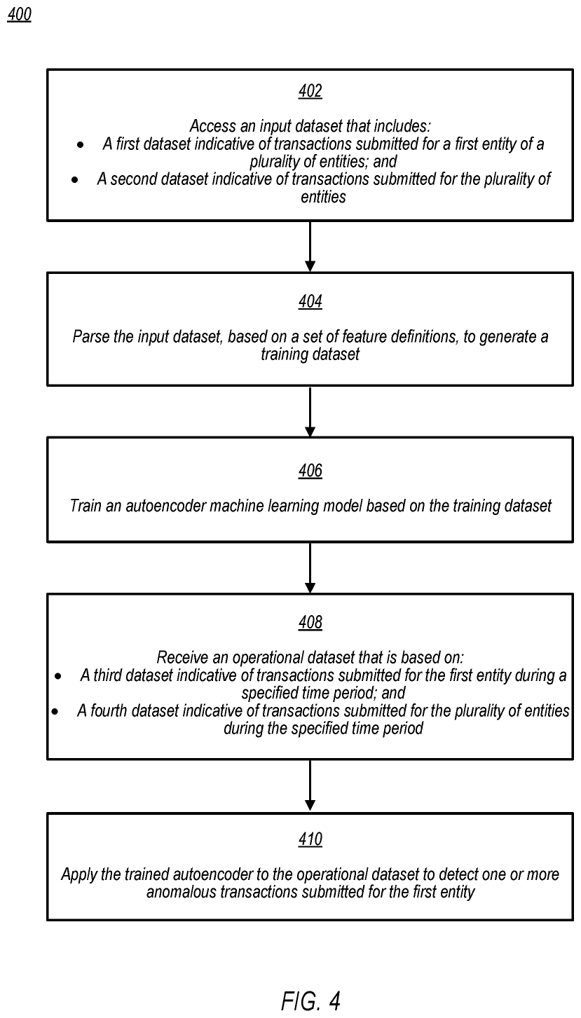

Turning now to FIG. 4, a flow diagram illustrating an example method 400 for detecting anomalous transactions using machine learning is depicted, according to some embodiments. In various embodiments, method 400 may be performed by anomaly detection module 112 of FIG. 1 to detect one or more anomalous transactions submitted to the transaction network 102 by entity 110A. For example, the computer system implementing the anomaly detection module 112 may include (or have access to) a non-transitory, computer-readable medium having program instructions stored thereon that are executable to cause the operations described with reference to FIG. 4. In FIG. 4, method 400 includes elements 402-410. While these elements are shown in a particular order for ease of understanding, other orders may be used. In various embodiments, some of the method elements may be performed concurrently, in a different order than shown, or may be omitted. Additional method elements may also be performed as desired.

At 402, in the illustrated embodiment, the anomaly detection module accesses an input dataset that includes: a first dataset indicative of transactions submitted for a first entity of a plurality of entities, and a second dataset indicative of transactions submitted for the plurality of entities. In some embodiments, for example, the anomaly detection module may access internal data 104A that is indicative of transactions submitted for entity 110A to the transaction network 102 during a given time period (e.g., 30 days) and market data 106 indicative of transactions submitted for all of the entities 110 during that same time period.

At 404, in the illustrated embodiment, the anomaly detection module parses the input dataset, based on a set of specified features, to generate a training dataset. For example, in the embodiment of FIG. 2, data processing module 204 may parse the internal data 104 and market data 106, based on the feature set definitions 212, to create the feature dataset 214. Feature selection module 206 may then select a reduced set of features from feature dataset 214 to generate training dataset 216. Note that, in some embodiments, data processing module may validate the input dataset 202 prior to analyzing it based on the feature set definitions 212 (e.g., to verify that there are not missing fields, manual entries, datapoints out of ranges, or any other data quality check).

At 406, in the illustrated embodiment, the anomaly detection modules trains an autoencoder machine learning model based on the output training dataset. With reference to FIG. 2, for example, the anomaly detection module 112 uses the training dataset 216 to train the autoencoder neural network 208. As discussed above, the trained autoencoder, in various embodiments, is operable to detect outlier observations within a dataset, such as anomalous transactions submitted to transaction network 102.

For example, at 408 in the illustrated embodiment, the anomaly detection module receives an operational dataset (e.g., operational dataset 218 of FIG. 2) that is based on a third dataset (e.g., internal data 222) indicative of transactions submitted to the transaction network for the first entity during a specified time period and a fourth dataset (e.g., market data 224) indicative of transactions submitted to the transaction network for the plurality of entities during the specified time period.

At 410, in the illustrated embodiment, the anomaly detection module applies the autoencoder machine learning model to the operational dataset to detect one or more anomalous transactions submitted for the first entity during the specified time period. In some embodiments, for example, element 410 may include applying a first record from the operational dataset to the autoencoder machine learning model to determine a reconstruction error associated with the first record, where the first record corresponds to a first transaction submitted for the first entity. The anomaly detection module may then compare the reconstruction error for the first record to an error threshold and, in response to the reconstruction error exceeding the error threshold, designating the first transaction as anomalous. In some embodiments, the anomaly detection module may further be operable to generate a list ranking the one or more anomalous transactions (e.g., anomalous transactions 220 identified by trained autoencoder 210) based on an anomaly detection score. In some embodiments, this anomaly detection score is indicative of a degree of deviation of an anomalous transaction from the patterns learned by autoencoder 210 during a model development phase.

As noted above, the disclosed systems and methods allow for anomaly detection that is proactive in nature, rather than prior rules-based systems that rely on an analyst to write a specific rule to identify a pattern of behavior. As such, in various embodiments, the one or more anomalous transactions identified by the autoencoder 210 may correspond to a pattern of transaction behavior that was not previous provided to the anomaly detection module 112 by a human analyst.

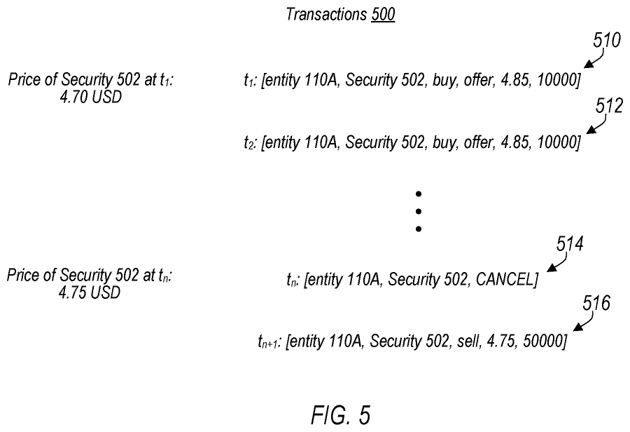

FIG. 5 depicts a series of transactions 500 submitted to transaction network 102 of FIG. 1 for entity 110A. More specifically, the transactions 500 depicted in FIG. 5 demonstrate a simplified example in which a trading entity 110A uses spoofing, a form of market manipulation, to artificially increase the market price for a security that entity 110A already owns. Entity 110A may leverage this price increase to obtain higher returns that it would have otherwise been able to without resorting to this illicit trading behavior.

FIG. 5 depicts transactions 510-516 submitted to the transaction network by entity 110A during a given time period between time t₁ and tₙ₊₁. Note that, in various embodiments, entity 110A may engage in high-frequency trading and may submit transactions to network 102 within milliseconds or microseconds of each other. In the depicted embodiment, assume that entity 110A already owns a large number (e.g., 50,000) of shares of stock for Security 502 at time t₁. Further, as shown in FIG. 5, assume that the price per share of Security 502 at time t₁ is $4.70 USD. At time t₁, entity 110A submits transaction 510 to transaction network 102. Transaction 510, in the illustrated embodiment, is an offer to buy 10,000 shares of Security 502 at a price of $4.85, above the present price for Security 502. At time t₂, in the illustrate embodiment, entity 110A submits another transaction 512 to the transaction network 102, again offering to buy Security 502 above the market price. In some embodiments, entity 110A may proceed to submit transactions to transaction network 102 in a similar manner until it observes a desired increase in the market price for Security 502. For example, in FIG. 5, the actions of entity 110A may, in part, cause the price of Security 502 to rise to $4.75 USD by time tₙ.

Once the market responds and the price of Security 502 increases, entity 110A may take actions to use this artificial price increase to its advantage. For example, at time tₙ, entity 110A may submit transaction 514 canceling its previously submitted offers (e.g., the orders in transactions 510 and 512) to buy Security 502 before that offer can be fulfilled by any of the other entities 110. Then, at time tₙ₊₁, entity 110A may submit transaction 516 offering to sell its supply of Security 502 at this higher price, allowing entity 110A to obtain higher returns for this security than it could have otherwise obtained without illicit trading behavior.

In various embodiments, the disclosed systems and methods may be used to identify this illicit trading behavior when performing trade surveillance operations for entity 110A. For example, the details of the transactions 500 may be included in operational dataset 218 provided to anomaly detection module 112. Anomaly detection module 112 may then use autoencoder 210 to analyze the operational dataset 218 and identify one or more of the transactions 500 as anomalous. Note that, for a given pattern of illicit trading behavior, anomaly detection module 112 may identify an individual transaction (e.g., transaction 514) as anomalous or may identify multiple transactions within that trading pattern as anomalous (e.g., transactions 514 and 516, all of transactions 510-516, etc.). Further note that the depicted embodiment is provided merely as an example and is not intended to limit the scope of the present disclosure. In other embodiments, the disclosed systems and methods may be used to detect any of various forms of anomalous trading behavior.

Although various embodiments have been described in the context of trade surveillance, these examples are not intended to limit the scope of the present disclosure. In other embodiments, the disclosed techniques for detecting anomalous transactions using machine learning may be implemented in various other contexts. As one non-limiting example, the disclosed systems and methods may be used by an online payment system to detect fraudulent transactions, according to some embodiments. For example, the online payment system may provide an online payment service used to facilitate transactions for various merchants. In some such embodiments, the online payment service may use the transaction data for these various merchants as training data to train an autoencoder, as described above. However, instead of training the autoencoder to detect anomalous securities transactions, as in the example above, the online payment system may train the autoencoder based on a set of features relevant for the detection of fraudulent transactions. The online payment system may then use the trained autoencoder to identify fraudulent transactions that deviate from the patterns learned by the autoencoder during the model development phase.

### Example Computer System

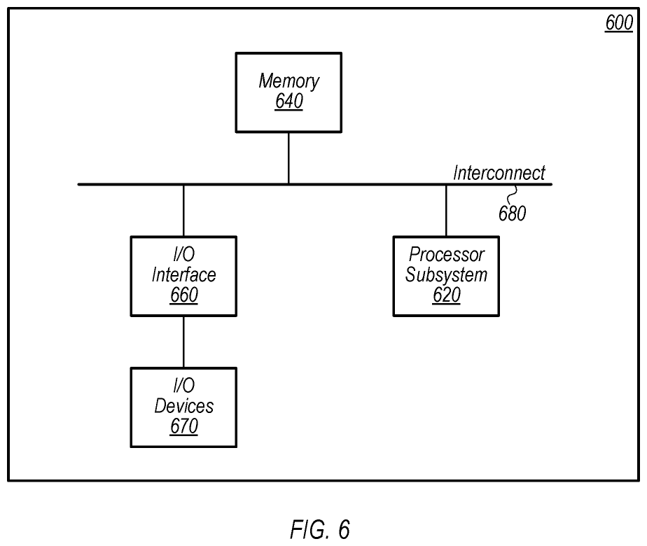

Referring now to FIG. 6, a block diagram of an example computer system 600 is depicted, which may implement one or more computer systems, such as a computer system used to implement anomaly detection module 112 of FIG. 1, according to various embodiments. Computer system 600 includes a processor subsystem 620 that is coupled to a system memory 640 and I/O interfaces(s) 660 via an interconnect 680 (e.g., a system bus). I/O interface(s) 660 is coupled to one or more I/O devices 670. Computer system 600 may be any of various types of devices, including, but not limited to, a server computer system, personal computer system, desktop computer, laptop or notebook computer, mainframe computer system, server computer system operating in a datacenter facility, tablet computer, handheld computer, workstation, network computer, etc. Although a single computer system 600 is shown in FIG. 6 for convenience, computer system 600 may also be implemented as two or more computer systems operating together.

Processor subsystem 620 may include one or more processors or processing units. In various embodiments of computer system 600, multiple instances of processor subsystem 620 may be coupled to interconnect 680. In various embodiments, processor subsystem 620 (or each processor unit within 620) may contain a cache or other form of on-board memory.

System memory 640 is usable to store program instructions executable by processor subsystem 620 to cause system 600 perform various operations described herein. System memory 640 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 600 is not limited to primary storage such as system memory 640. Rather, computer system 600 may also include other forms of storage such as cache memory in processor subsystem 620 and secondary storage on I/O devices 670 (e.g., a hard drive, storage array, etc.). In some embodiments, these other forms of storage may also store program instructions executable by processor subsystem 620.

I/O interfaces 660 may be any of various types of interfaces configured to couple to and communicate with other devices, according to various embodiments. In one embodiment, I/O interface 660 is a bridge chip (e.g., Southbridge) from a front-side to one or more back-side buses. I/O interfaces 660 may be coupled to one or more I/O devices 670 via one or more corresponding buses or other interfaces. Examples of I/O devices 670 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 670 includes a network interface device (e.g., configured to communicate over WiFi, Bluetooth, Ethernet, etc.), and computer system 600 is coupled to a network via the network interface device.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for” [performing a function] construct.

In this disclosure, various “modules” operable to perform designated functions are shown in the figures and described in detail above (e.g., anomaly detection module 112, data processing module 204, etc.). As used herein, the term “module” refers to circuitry configured to perform specified operations or to physical, non-transitory computer-readable media that stores information (e.g., program instructions) that instructs other circuitry (e.g., a processor) to perform specified operations. Such circuitry may be implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority hereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
accessing, by a computer system, an input dataset that includes:
a first dataset indicative of transactions submitted to a transaction network for a first entity of a plurality of entities; and
a second dataset indicative of transactions submitted to the transaction network for the plurality of entities;
parsing, by the computer system based on a set of feature definitions, the input dataset to determine a training dataset;
training, by the computer system, an autoencoder machine learning model based on the training dataset;
receiving, by the computer system, an operational dataset that is based on:
a third dataset indicative of transactions submitted to the transaction network for the first entity during a specified time period; and
a fourth dataset indicative of transactions submitted to the transaction network for the plurality of entities during the specified time period; and
applying, by the computer system, the autoencoder machine learning model to the operational dataset to detect one or more anomalous transactions submitted for the first entity during the specified time period.

2. The method of claim 1, wherein the applying the autoencoder machine learning model to detect the one or more anomalous transactions includes:
applying a first record from the operational dataset to the autoencoder machine learning model to determine a reconstruction error for the first record, wherein the first record corresponds to a first transaction submitted for the first entity;
comparing the reconstruction error for the first record to an error threshold; and
in response to the reconstruction error exceeding the error threshold, designating the first transaction as an anomalous transaction.

3. The method of claim 1, further comprising:
generating, by the computer system, a list ranking the one or more anomalous transactions submitted for the first entity during the specified time period based on anomaly scores for the one or more anomalous transactions.

4. The method of claim 3, wherein the anomaly scores respectively correspond to reconstruction errors for records associated with the one or more anomalous transactions.

5. The method of claim 3, wherein the list further specifies one or more features used to designate the one or more anomalous transactions as anomalous.

6. The method of claim 1, wherein the one or more anomalous transactions correspond to a pattern of transaction behavior that was not previously provided to the computer system by a human analyst.

7. The method of claim 1, wherein the one or more anomalous transactions are identified, by the autoencoder machine learning model, based on a plurality of features included in the set of feature definitions, and wherein the transaction network is included in a high-frequency trading system.

8. A non-transitory, computer-readable medium having instructions stored thereon that are capable of execution by a computer system to perform operations comprising:
accessing an input dataset that includes:
a first dataset indicative of transactions submitted to a transaction network for a first entity of a plurality of entities; and
a second dataset indicative of transactions submitted to the transaction network for the plurality of entities;
parsing, based on a set of feature definitions, the input dataset to determine a training dataset;
training an autoencoder machine learning model based on the training dataset;
receiving an operational dataset that is based on:
a third dataset indicative of transactions submitted to the transaction network for the first entity during a specified time period; and
a fourth dataset indicative of transactions submitted to the transaction network for the plurality of entities during the specified time period; and
applying the autoencoder machine learning model to the operational dataset to detect one or more anomalous transactions submitted for the first entity during the specified time period.

9. The non-transitory, computer-readable medium of claim 8, wherein applying the autoencoder machine learning model to detect the one or more anomalous transactions includes:
applying a first record from the operational dataset to the autoencoder machine learning model to determine a reconstruction error for the first record, wherein the first record corresponds to a first transaction submitted for the first entity;
comparing the reconstruction error for the first record to an error threshold; and
in response to the reconstruction error exceeding the error threshold, designating the first transaction as an anomalous transaction.

10. The non-transitory, computer-readable medium of claim 8, wherein the operations further comprise:
generating, by the computer system, a list ranking the one or more anomalous transactions submitted for the first entity during the specified time period based on anomaly scores for the one or more anomalous transactions.

11. The non-transitory, computer-readable medium of claim 10, wherein the anomaly scores respectively correspond to reconstruction errors for records associated with the one or more anomalous transactions.

12. The non-transitory, computer-readable medium of claim 8, wherein the one or more anomalous transactions correspond to a pattern of transaction behavior that was not previously provided to the computer system by a human analyst.

13. The non-transitory, computer-readable medium of claim 8, wherein the one or more anomalous transactions are identified, by the autoencoder machine learning model, based on a plurality of features included in the set of feature definitions, and wherein the transaction network is included in a high-frequency trading system.

14. The non-transitory, computer-readable medium of claim 8, wherein the computer system receives the operational dataset from a second computer system associated with the first entity, and wherein the operations further comprise:
sending, to the second computer system associated with the first entity, a report identifying the one or more anomalous transactions submitted for the first entity during the specified time period.

15. A system, comprising:
a non-transitory memory storing instructions; and
a processor configured to execute the instructions to cause the system to:
access an input dataset that includes:
a first dataset indicative of transactions submitted to a transaction network for a first entity of a plurality of entities; and
a second dataset indicative of transactions submitted to the transaction network for the plurality of entities;
parse, based on a set of features definitions, the input dataset to determine a training dataset; and
train an autoencoder machine learning model based on the training dataset, wherein, after training, the autoencoder machine learning model is operable to process an operational dataset to detect one or more anomalous transactions submitted for the first entity during a specified time period.

16. The system of claim 15, wherein executing the instructions further causes the system to:
send information indicative of the trained autoencoder machine learning model to a computer system associated with the first entity.

17. The system of claim 15, wherein executing the instructions further causes the system to:
access the operational dataset, wherein the operational dataset is based on:
a third dataset indicative of transactions submitted to the transaction network for the first entity during the specified time period; and
a fourth dataset indicative of transactions submitted to the transaction network for the plurality of entities during the specified time period; and
apply the autoencoder machine learning model to the operational dataset to detect the one or more anomalous transactions submitted for the first entity during the specified time period.

18. The system of claim 17, wherein the one or more anomalous transactions correspond to a pattern of transaction behavior that was not previously provided to the system by a human analyst.

19. The system of claim 17, wherein executing the instructions further causes the system to:
apply a first record from the operational dataset to the autoencoder machine learning model to determine a reconstruction error for the first record, wherein the first record corresponds to a first transaction submitted for the first entity;
compare the reconstruction error for the first record to an error threshold; and
in response to the reconstruction error exceeding the error threshold, designate the first transaction as an anomalous transaction.

20. The system of claim 19, wherein executing the instructions further causes the system to:
generate a list ranking the one or more anomalous transactions submitted for the first entity during the specified time period based on anomaly scores for the one or more anomalous transactions.
